(19) United States
(12) Patent Application Publication
(10) Pub. No.: US 2010/0242951 A1
(43) Pub. Date: Sep. 30, 2010

(54) APPARATUS FOR INHIBITING PRESSURE FLUCTUATIONS AND MOISTURE CONTAMINATION WITHIN SOLAR COLLECTORS AND MULTI-GLAZED WINDOWS

(76) Inventor: Paul B. Soucy, Methuen, MA (US)

Correspondence Address: Vern Maine & Associates, 547 AMHERST STREET, 3RD FLOOR, NASHUA, NH, 03063-4000, US

(21) Appl. No.: 12/751,114

(22) Filed: Mar. 31, 2010

Related U.S. Application Data
(60) Provisional application No. 61/165,183, filed on Mar. 31, 2009.

(51) Int. Cl. F24J 2/22; B01D 53/02

(52) U.S. Cl. 126/675; 96/113

(57) ABSTRACT

A solar collector or multi-glazed window includes a desiccant-filled vent which reduces chamber pressure fluctuations, thereby minimizing failure of seals, while inhibiting contamination by moisture. Excess pressure due to solar-heated gas is vented from the chamber, and insufficient pressure due to cooled gas is relieved by additional gas entering the chamber after being dried by the desiccant. Expandable chamber seals can further mitigate pressure fluctuations by enabling chamber dimensions to vary as the gas temperature changes. When the sun warms the desiccant, absorbed moisture is carried away by venting, solar-heated gas. A purging system can fill and purge the chamber, and a dry gas source can provide input gas at a slightly elevated pressure. A pressurized, gas-maintenance system can maintain a constant overpressure in a plurality of chambers. Solar absorbers can be formed by one or two corrugated sheets having fluid tubes installed in channels formed therein or therebetween.

### RELATED APPLICATIONS

This application claims the benefit of U.S. Provisional Application No. 61/165,183, filed Mar. 31, 2009, incorporated herein by reference in its entirety for all purposes.

### FIELD OF THE INVENTION

The invention relates to sealed, double-panel, light-admitting and/or light transmitting chambers such as solar collectors and double-glazed windows, and more specifically to apparatus for inhibiting entry of moisture into such sealed chambers.

### BACKGROUND OF THE INVENTION

A solar heat collector is a device used to convert solar energy into heat energy and to transfer that heat energy to a selected solid or fluid mass. In a solar heat collector, sunlight typically impinges on an absorber plate, which absorbs light energy from the sun and converts it into heat. In most cases, the absorber plate is covered by a transparent panel made from glass, Plexiglas, or a similar material, which is spaced apart from the absorber plate and sealed to the absorber plate so as to create a chamber therebetween that allows light to enter and to reach the absorber plate, but prevents heat from escaping before it has been absorbed by the solid or fluid mass. In the case of a fluid mass, the fluid may be a liquid or a gas, including water or air. Typically, the fluid mass is contained for heating in a circulation loop that flows through the solar collector. It may be an open-loop or a closed-loop fluid circulation system.

In a passive solar heat collector, the fluid flow through the collector is sustained by the heat energy imparted to the fluid, such as by heating air to keep it rising vertically through the plenum of a solar collector. In an active solar heat collector, there is a pumping force that provides fluid flow through the solar collector, such as an air blower or a water circulator. In either case, there may be various sensors and controls affecting fluid flow through the collector to optimize and/or limit the light-to-heat conversion and heat transfer process to achieve the desired heating result.

Double-glazed and triple-glazed windows have a primary function of thermally insulating an interior space from an exterior space by trapping air or another gas between adjacent layers of glass. The gas layer transmits light into the interior space, but does not readily conduct heat out of the interior space. The function of a multiple-glazed window is essentially identical to the function of a solar heat collector, in that light is admitted into a chamber in which a gas is trapped so as to prevent a flow of heat through or out of the chamber. The only difference is that one panel of a solar collector is light absorptive, while both panels of a double-glazed window are transparent to light.

Both solar heat collectors and double-glazed or multi-glazed windows are typically plagued with the problem of moisture accumulation within the space or chamber formed between the transparent outer layer or wall of the chamber and the absorber plate of a solar collector, or the next transparent layer in a window. The accumulation of moisture in the chamber eventually leads to functional and/or esthetic deterioration of the device. This is most readily apparent when moisture from inside a building, typically infiltrating through a compromised seal, condenses on the inside surface of the cooler chamber wall, typically the outer layer or transparent glass plate of the chamber. Even gas-filled chambers in sealed multi-pane windows and solar heat collectors eventually succumb to seal failure due to the extreme cycles of thermal heating and cooling to which they are subjected, and the resulting cycles of gas pressure within the chambers. Thereafter, moisture infiltrates through the failed seal due to the repetitive cycles of in-gassing and out-gassing induced by the continuing temperature reversals and consequent pressure changes that occur with daily and seasonal cycles of solar exposure. Note that the term “solar collector” as used herein is intended to be inclusive of double-glazed and other multi-glazed windows in so far as the context admits, and except where expressly stated otherwise.

### SUMMARY OF THE INVENTION

One aspect of the present invention is a solar collector or multi-glazed window comprising a sealed chamber of fixed volume formed between a light transmissive layer and an adjacent layer, the sealed chamber being filled with air or another gas, wherein a vent or breathing port is provided that enables gas communication through a desiccant plug between the interior of the chamber and an exterior gas or air environment. Changes in the air or gas temperature and pressure within the chamber cause gas to flow through the desiccant material, thereby minimizing pressure changes within the chamber and minimizing stresses applied to the chamber seals. This significantly extends the lives of the chamber seals while at the same time inhibiting entry of moisture into the chamber.

Another aspect of the present invention is a solar collector or multi-glazed window comprising a sealed chamber of expandable volume formed between a light transmissive layer and an adjacent layer. The chamber volume is able to expand and contract in response to changes in the temperature of the gas sealed within the chamber, thereby minimizing pressure changes within the chamber and significantly extending the life of the chamber seals. In some embodiments, the sealed chamber is configured with a charging system by which the chamber can be coupled to a source of a suitably light-transmissive gas, thereby enabling the chamber to be purged and filled with the light transmissive gas. The charging system may consist of one or more ports or tubes, such as an inlet tube and an outlet port, configured with suitable control valves, check valves, pressure relief valves, and/or simple shut off valves, as will be well understood by one of ordinary skill in the art. The gas can be dry air or a gas, such as argon, krypton, or nitrogen, which is suitable for the application. Typically, the chamber is filled to a slight overpressure or positive pressure with respect to ambient pressure and temperature and then sealed.

Yet another aspect of the present invention is a solar absorber plate comprising at least one layer of corrugated, heat-conductive sheet material which is configured with a light absorbent exterior surface. Heat-conductive tubes are located within the channels formed on one side of the corrugated sheet, the tubes being in thermal contact with the heat-absorbing corrugated material. The ends of the tubes are made available for interconnection, and/or for connection to a fluid circulation system.

In some embodiments, the heat-conductive tubes are attached to the corrugated sheet by ultrasonic welding, laser welding, and/or other attachment means known in the art.

Various embodiments include two layers of corrugated, heat conductive sheet material, at least one of which is configured with a light absorbent exterior surface, the two layers being configured with their corrugations aligned and offset such that a pattern of channels is created between opposing corrugations, the adjacent channels being separated by mating flats of the corrugated sheet material. In various of these embodiments the corrugated sheets are joined to each other by bonding together of the mating flats using attachment methods known in the art, including but not limited to laser and ultrasonic welding, spot welding of any type, through-hole fasteners, continuous or spot bonding with adhesives, and/or other attachment means known in the art. The corrugations provide sufficient resistance to deformation so that a continuous bond line is not required. The heat-conductive tubes are located within the channels formed thereby, the tubes being in thermal contact with the heat-absorbing corrugated material.

While some solar collectors convert solar radiation to heat energy, other solar collectors include photovoltaic cells and other devices that convert solar radiation into electrical energy. The present invention in this aspect is applicable to photovoltaic cells and other devices to the extent that the photovoltaic cells or other devices employ, are configured with, or are incorporated into a solar collector that has a light-transmissive but thermally insulating gas or other fluid confined within a chamber with a transparent outer layer disposed directly over the photovoltaic cells or other devices, solar radiation being directed through the transparent outer layer onto the photovoltaic cells or other devices.

The present invention is a solar device having a pressure-stabilized chamber into which moisture entry is inhibited. The solar device includes a first, light-transmissive panel, a second panel adjacent to the first panel, the first panel and the second panel being maintained in a spaced-apart relationship by at least one joining seal, so as to form a solar chamber therebetween, a venting system configured to provide gas communication between the solar chamber and an exterior gas environment so as to minimize temperature-induced pressure fluctuations within the sealed chamber, and a desiccant-filled chamber cooperative with the venting system and configured so as to require gas to pass through the desiccant-filled chamber and be dried thereby before flowing into the solar chamber.

In some embodiments, the second panel is a light-transmissive panel. In other embodiments, the second panel is a solar energy absorbing panel. And in certain embodiments the venting system is a vent tube.

In various embodiments the venting system and desiccant-filled chamber are configured so as to require gas flowing out of the sealed chamber to flow through the desiccant-filled chamber.

In some embodiments, the at least one joining seal maintains the first and second panels in a spaced-apart relationship having a fixed distance therebetween. In other embodiments the at least one joining seal maintains the first and second panels in a spaced-apart relationship having a distance therebetween that is variable in response to temperature changes of a gas contained within the solar chamber, thereby mitigating pressure changes of the gas contained within the solar chamber.

In various embodiments the desiccant-filled chamber is removable from the solar device. Some embodiments further include a venting valve that can be adjusted so as to at least restrict gas flow through the vent passage. And certain embodiments further include a gas flow control system configured to permit flow of gas between the sealed chamber and the exterior gas environment only when a predetermined pressure differential exists between the sealed chamber and the exterior gas environment.

Some embodiments further include a recharging system configured for purging and replenishing gas within the chamber. Some of these embodiments further include a recharging valve that can be shut so as to prevent gas flow through the recharging system. In other of these embodiments the recharging system is removable from the solar device.

In various embodiments the gas is one of air, nitrogen, argon, and krypton.

In certain embodiments the second panel is a solar energy absorbing panel formed by a corrugated sheet having corrugation channels therein, the corrugated sheet having a light-absorbing exterior surface, at least some of the corrugation channels having fluid-conducting tubes installed therein and attached thereto, each of the fluid-conducting tubes being in thermal communication with the corrugated sheet, ends of the fluid-conducting tubes being available for connection to a fluid circulation system.

In various embodiments the second panel is a solar energy absorbing panel formed by two corrugated sheets, at least one of the corrugated sheets having a light-absorbing exterior surface, the corrugated sheets being fixed to each other in a parallel and offset alignment so as to cause opposing corrugations to form parallel channels therebetween, the channels being separated by joinable flats, at least some of the channels having fluid-conducting tubes installed therein, each fluid-conducting tube being in thermal communication with the at least one corrugated sheet having a light-absorbing exterior surface, ends of the fluid-conducting tubes being available for connection to a fluid circulation system.

Some embodiments further include an insulated shell, the insulated shell being cooperative with the first and second panels so as to form a hot-air plenum bounded by the second panel and the insulated shell. Other embodiments further include fluid-conduction tubing configured so as to bring a fluid flowing through the tubing into thermal communication with the second panel.

In various embodiments the source of dry gas is a controlled source of dry gas configured so as to maintain a gas pressure within the chamber which is elevated above a surrounding ambient air pressure.

In certain embodiments, the exterior gas environment is a gas maintenance system which includes a pressurized source of gas having a pressure-regulated output, and an expansion chamber having a volume which is at least ten times greater than a volume of the solar chamber. And in some of these embodiments the gas maintenance system is configurable so as to provide the exterior gas environment for a plurality of solar devices

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a partial cross section view of a solar collector illustrating an absorber plate and a glass outer layer sealed together in a spaced-apart, parallel relationship by a silicone gasket so as to form a sealed chamber therebetween, the sealed chamber being attached to an insulated collector base and configured with a small vent that pierces the absorber plate and the back wall of the base, by which the chamber is vented to outside air, the vent being configured with a removable desiccant breathable plug;

FIG. 2 is a partial cross section view of a solar collector similar to FIG. 1, except that the chamber vent pierces the side wall and silicon gasket rather than the back wall and absorber plate;

FIG. 3A is a partial cross section view of a solar collector similar to FIG. 2, except that the silicone gasket is expandable so as to form an expandable chamber;

FIG. 3B is a functional diagram of a plurality of solar collectors all of which are supplied with a slight overpressure of gas through a manifold from a common source;

FIG. 4 is a partial cross section view of a solar collector illustrating an absorber plate and a glass outer layer sealed together in a spaced-apart parallel relationship by an expandable silicone gasket so as to form an expandable chamber, the chamber being attached to an insulated collector base and configured with a chamber charging system including a charging tube piercing the absorber plate by which the chamber may be filled and/or purged with a gas, the charging system further including a valve that can seal the chamber after charging;

FIG. 5 is a partial cross section view of a solar collector similar to FIG. 4, wherein the potting of the glass and absorber assembly to the front side of the collector shell permits removal of the glass and absorber assembly from the front of the collector shell by cutting or otherwise removing or destroying the potting; and the potting of the insulated backside to the collector shell permits removal for access of the backside of the collector shell, for example from the inside of a building, by cutting or otherwise removing or destroying the potting;

FIG. 6 is a partial cross section view of a solar collector illustrating an absorber plate and a glass outer layer assembly sealed together in a spaced-apart parallel relationship by an expandable gasket made from silicone, rubber, or other suitable gasket material so as to form an expandable chamber similar to FIG. 4, wherein the gasket is shown to be sealed to the glass and the absorber plate on three surfaces, in contrast to the adjacent conventional double-glazed window, both of which are secured by a batten to the same structural member;

FIG. 7 is a partial cross section view of a solar collector illustrating an absorber plate and a glass outer layer sealed together in a spaced-apart parallel relationship by an expandable silicone gasket so as to form an expandable chamber, the chamber being attached to an insulated collector base and configured with a chamber charging system including a charging tube piercing the absorber plate and the sidewall of the base, by which the chamber may be filled and/or purged with a gas, the charging system being configured with a valve to seal the chamber after charging;

FIG. 8 is a partial cross section view of a solar collector illustrating an absorber plate and a glass outer layer sealed together in a spaced-apart parallel relationship by a silicone gasket so as to form a sealed chamber, the chamber being attached to an insulated collector base and configured with a chamber charging system including a charging tube piercing the absorber plate and the backside of the base, by which the chamber may be filled and/or purged with a gas, the charging system connecting the chamber to an expandable volume (not shown) and being configured with a valve stem to seal the chamber and expandable volume after charging;

FIG. 9 is a partial cross section view of a solar collector illustrating an absorber plate conductively incorporating heating tubes for a hot water system, and a glass outer layer, sealed together in a spaced-apart parallel relationship by an expandable silicone gasket so as to form an expandable sealed chamber, the chamber being attached to an insulated collector base and configured with a chamber charging system including a charging tube piercing the absorber plate and the backside of the base by which the chamber may be filled and/or purged with a gas, the charging system being configured with a valve stem to seal the chamber after charging, the heating tubes being connected to headers, the headers being connectable by flexible couplings to a hot water or other fluid circuit, including a Freon heating or cooling circuit;

FIG. 10 is a partial cross section view of a solar collector illustrating an absorber plate conductively incorporating portions of a serpentine heating coil for a hot water system, and a glass outer layer, sealed together in a spaced-apart parallel relationship by an expandable silicone gasket so as to form an expandable sealed chamber, the chamber being attached to an insulated collector base and configured with a chamber charging system including a charging tube piercing the absorber plate and the backside of the base, by which the chamber may be filled and/or purged with a gas, the charging system being configured with a valve to seal the chamber after charging, the serpentine coil being connectable to a hot water heating circuit;

FIG. 11A is a partial cross section diagram of an absorber plate formed by a single sheet of corrugated material and heating tubes bonded to the sheet within corrugations thereof; and

FIG. 11B is a partial cross section diagram of an absorber plate formed by joining two aligned and offset sheets of corrugated material and conductively incorporating heating tubes in spaces formed between opposing corrugations.

### DETAILED DESCRIPTION OF THE INVENTION

The invention is susceptible of many embodiments. What is described and shown is illustrative but is not exhaustive of the scope of the invention.

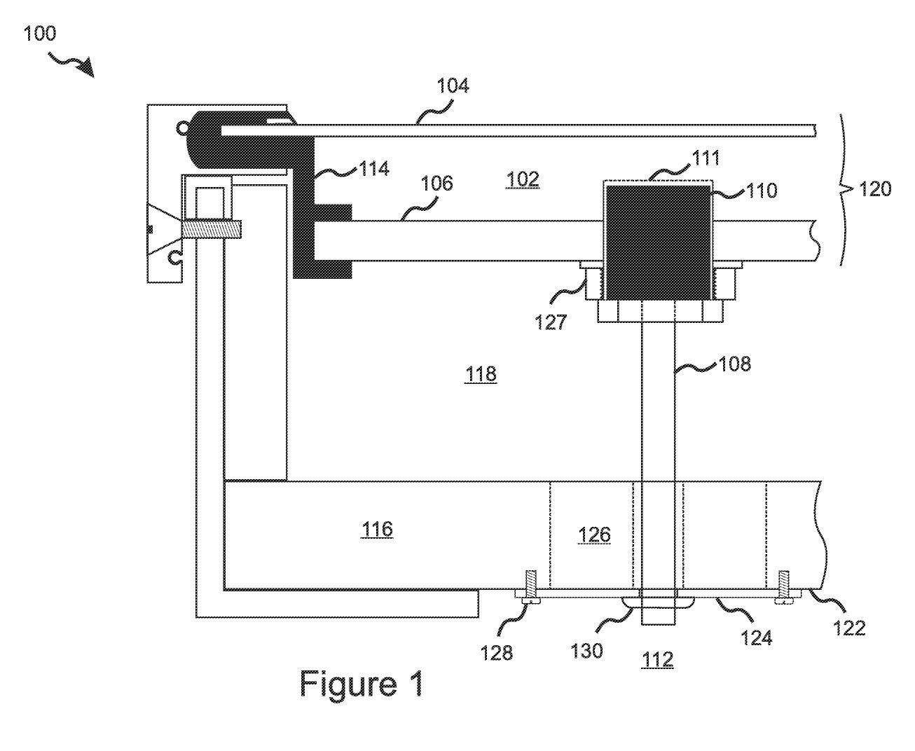

Referring to FIG. 1, one aspect of the present invention is a solar collector or multi-glazed window 100 comprising a chamber 102 formed between a light transmissive layer 104 and an adjacent layer 106, the chamber 102 being filled with air or with another gas. The chamber 102 is sealed except for a vent or breathing port 108 which enables air or another gas to be exchanged between the chamber 102 and an exterior gas or air environment 112 through a desiccant plug 110 that removes moisture from the air or other gas before it enters the chamber 102. Subsequent heating of the desiccant plug 110 by direct solar irradiation and/or by conductive heating from the adjacent layer 106 causes the absorbed moisture to leave the desiccant plug and flow out from the chamber 102 as the warming gas within the chamber 102 expands and flows out through the desiccant plug 110. In the embodiment of FIG. 1, the desiccant plug 110 is covered by a gas-permeable screen 111, so as to contain the desiccant while allowing gas to flow through.

Changes in the gas temperature and pressure within the chamber 102 cause gas to flow in and out of the chamber 102 through the desiccant plug 110, thereby minimizing pressure changes within the chamber 102 and minimizing flexing stresses applied to the chamber seals 114. This reduction in flexing stresses significantly extends the lives of the chamber seals 114, while at the same time the desiccant plug 110 inhibits entry of moisture into the interior of the chamber 102.

The specific embodiment of FIG. 1 is a solar heat collector 100 that includes a solar absorption assembly 120 comprising a glass panel 104 and a light absorber 106 held in parallel relationship to each other by a silicon seal 114 and forming therebetween a chamber 102 of fixed dimensions. The chamber assembly 120 is affixed to an insulated base 116 so as to form a hot air plenum 118 therebetween. In the embodiment of FIG. 1, air flows both into and out of the chamber 102 through the desiccant plug 110, drying the air as it flows into the chamber 102, and purging the solar-heated desiccant plug 110 of absorbed moisture as the air flows out of the chamber 110. In similar embodiments, some or all of the air or other gas flows out of the chamber 102 through a separate tube and one-way valve that bypasses the desiccant plug 110, while air or gas flowing into the chamber 102 is required to flow through the desiccant plug 110.

Explained in more detail, the function of the vent 108 and desiccant plug 110 are as follows. During the daily cycle of solar exposure, the absorber plate 106 and the desiccant plug 110 are heated, thereby heating the air or other gas (herein referred to generically as “air”) in the chamber 102, causing the air to expand, and forcing an excess volume of air to flow from the chamber 102 through the desiccant plug 110 and out the vent 108. In the evening and through the night, the chamber 102 cools, causing the air within the chamber 102 to contract and drawing air back through the desiccant plug 110 and into the chamber 102. As the air flows in through the desiccant plug 110, the desiccant plug 110 dries the air by removing and retaining most of the moisture entrained in the incoming air, so that the moisture level in the chamber 102 remains lower than the moisture level in the ambient air 112. The next morning, during the heating cycle, the absorber plate 106 and the desiccant material 110 are heated, causing absorbed moisture to be released by the desiccant while the expanding air once again flows out of the chamber 102 through the plug 110 and transports the released moisture back into the outside air 112.

This process is repeated at some level for each significant reversal in chamber temperature, resulting in a moisture or humidity level within the chamber 102 which is consistently lower than the moisture content or humidity level of the outside air 112. This self-recharging, breathable, air drying feature of the chamber 102 has little effect on its immediate performance, and greatly reduces the degradation in function and appearance of the unit that accumulating moisture can otherwise cause over time.

In various embodiments, the desiccant plug 110 is removable and replaceable if and when required. In the embodiment of FIG. 1, the desiccant plug 110 and vent tube 108 are part of a desiccant plug assembly that also includes a base plate 124 and thermal insulation 126. The desiccant plug assembly is threaded into a mounting block 127 which is welded or otherwise permanently affixed to the absorber plate 106, and the vent tube 108 extends through the thermal insulation 126 and through a gasket 130 that is affixed to the base plate. When the screws 128 are removed, the base plate 124 and insulation 126 can be removed by sliding the gasket 130 over the vent tube 108. The desiccant plug 110 and vent tube 108 can then be removed, for replacement, drying, or refilling with fresh desiccant, by using a wrench to unscrew the desiccant plug 110 from the mounting block 127.

In certain embodiments, the vent tube 108 and/or desiccant plug 110 are restricted in size and/or otherwise configured so as to resist significant free flow or migration of air in and out of the chamber 102 that might otherwise alter the chamber's heat retention and/or heat transfer characteristics. In some of these embodiments the vent tube 108 is further configured to open at a preselected pressure or at preset pressure differentials arising from a measurable temperature change and resulting in a requirement for in-gassing or out-gassing of air through the desiccant material 110.

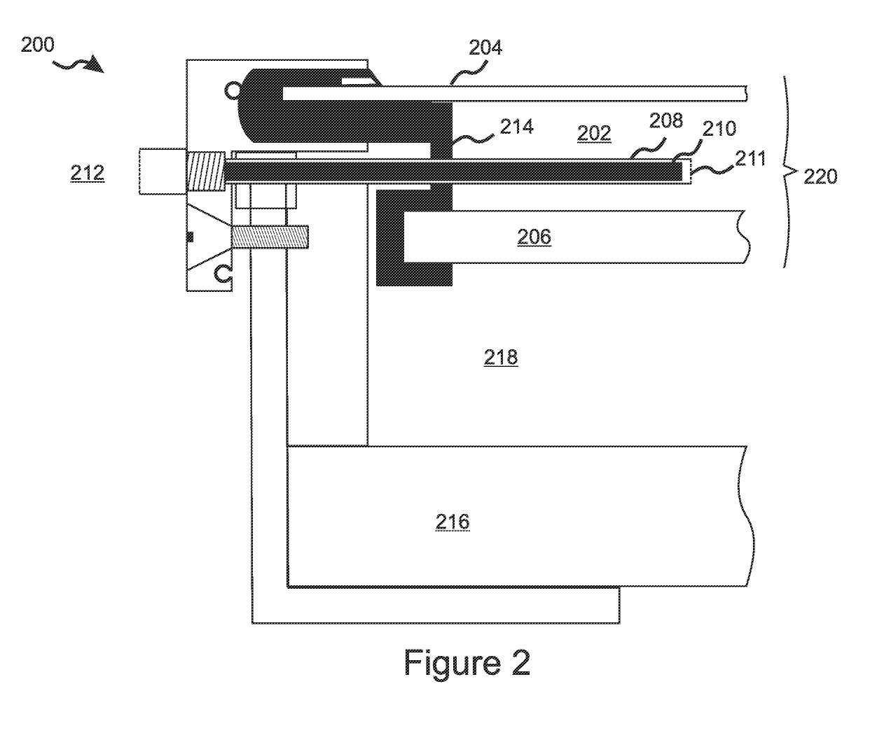

Referring now to FIG. 2, there is illustrated a partial cross section view of a solar collector similar to that of FIG. 1, including a solar absorption assembly 220 comprising an absorber plate 206 and a glass outer layer 204 sealed together in a spaced-apart parallel relationship by a silicone gasket 214, which in various embodiments is made of rubber or of another suitable material, so as to form a chamber 202 of fixed dimensions therebetween. The solar absorption assembly 220 is affixed to an insulated collector base 216 so as to form an air plenum 218 therebetween for a hot air heating system. The chamber 202 in this embodiment is configured with a small vent tube 208 which is filled with desiccant 210. The vent tube 208 penetrates the gasket 214 between the glass 204 and the absorber plate 206, and vents the chamber 202 through the desiccant 210 to outside air 212. The end of the vent tube 208 is covered by a screen 211, which maintains the desiccant 210 within the vent tube 208 while allowing air or another gas to flow through the vent tube 208. In the embodiment of FIG. 2, the desiccant-filled vent tube 208 is dark in color, so as to warm the vent tube 208 with absorbed light and cause absorbed moisture to be released by the desiccant 210 as warmed air flows out through the vent tube 208.

In various embodiments wherein the light absorber plate 206 is situated other than horizontal, the vent tube 208 and desiccant 210 are located at the lower edge of the absorber plate 206, so that condensate, should it occur, is directed by gravity to the vent tube 208. Embodiments 200 such as the one illustrated in FIG. 2 are suitable for being “let in” to a wall or roof, since the vent tube 208 outside air port is at the “top” of the sidewall, near the exposed or “solar” side of the collector unit 200.

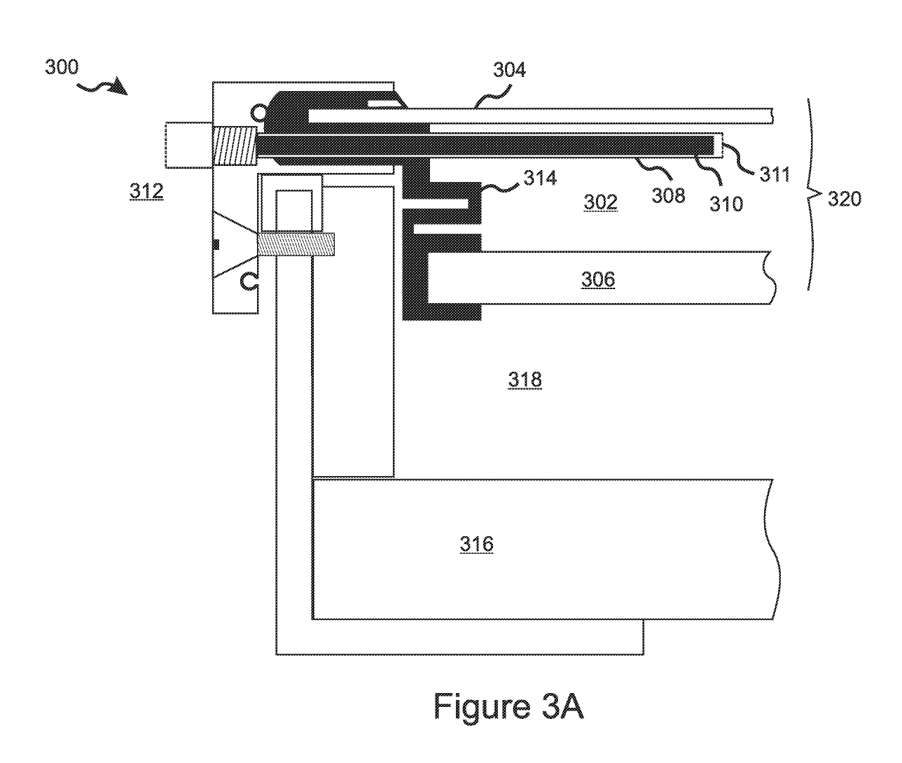

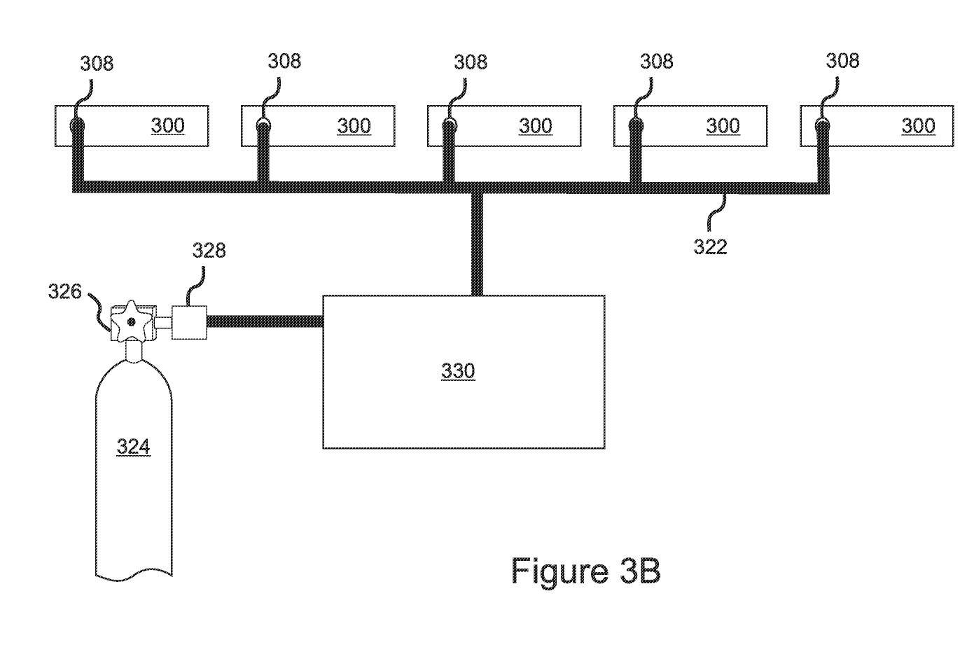

Referring now to FIG. 3A, there is shown a partial cross section view of a solar collector 300 having a solar absorption assembly 320 comprising an absorber plate 306 and a glass outer layer 304 sealed together in a spaced-apart parallel relationship by an expandable silicone gasket 314 so as to form an expandable chamber 302 therebetween. The solar absorption assembly 320 is affixed to an insulated collector base 316 so as to form a plenum 318 therebetween, whereby the top surface of the solar absorption assembly 320, which is the glass layer 304, is held stationary and the absorber plate 306 is suspended within the plenum 318 by the expandable gasket 314. The chamber 302 is configured with at least one small chamber vent tube 308 that penetrates through the sidewall and gasket 314 to the outside air 312, in a manner similar to the embodiment of FIG. 2. The chamber 302 experiences exchange of air through the vent tube 308 due to thermally driven changes in air volume within the chamber 302. The vent tube 308 is similar in configuration to the vent tube 208 of FIG. 2, being filled with desiccant 310 that leeches moisture from incoming air and is heated during solar exposure and dried or recharged by expanding, outgoing air.

The expandable gasket 314 also enables alteration of the chamber volume by movement of the absorber plate 306 towards or away from the glass 304. This provides, for example, the option to intentionally circulate air from the chamber 302 through a closed-loop dryer system (not shown) connected to the chamber 302 that can thereafter be disconnected and serviced. Alternatively, the expandable gasket 314 can be used in conjunction with the vent 308 so as to fill and pressurize the gas in the chamber 302, after which the vent 308 can be constricted or closed and the chamber volume 302 allowed to contract gradually as the gas in the chamber 302 bleeds down over time to ambient pressure. In various embodiments, the expandable gasket 314 by which the absorber plate 306 is suspended is configured with sufficient clearance from the base unit 316 to accommodate the normal movement of the absorber plate 306 that occurs with temperature change, and with no impact on the integrity of the seals 314.

Referring to FIG. 3B, a plurality of solar collectors 300 can be connected by a manifold 322 to a common source 324 of pressurized gas, so that all of the chambers 302 within the absorber assemblies 320 are maintained at a constant gas pressure that is slightly above ambient. In the embodiment of FIG. 3B, a high pressure gas cylinder 324 supplies gas at a desired pressure controlled by a regulator 326. An overpressure safety relief valve 328 is provided in case the regulator fails or the pressure rises for any other reason above a level that is safe for the absorber assembly 320. An expansion tank 330 is also included, which provides a large volume within which expanding gas from the absorbers can be received without a significant increase in the gas pressure.

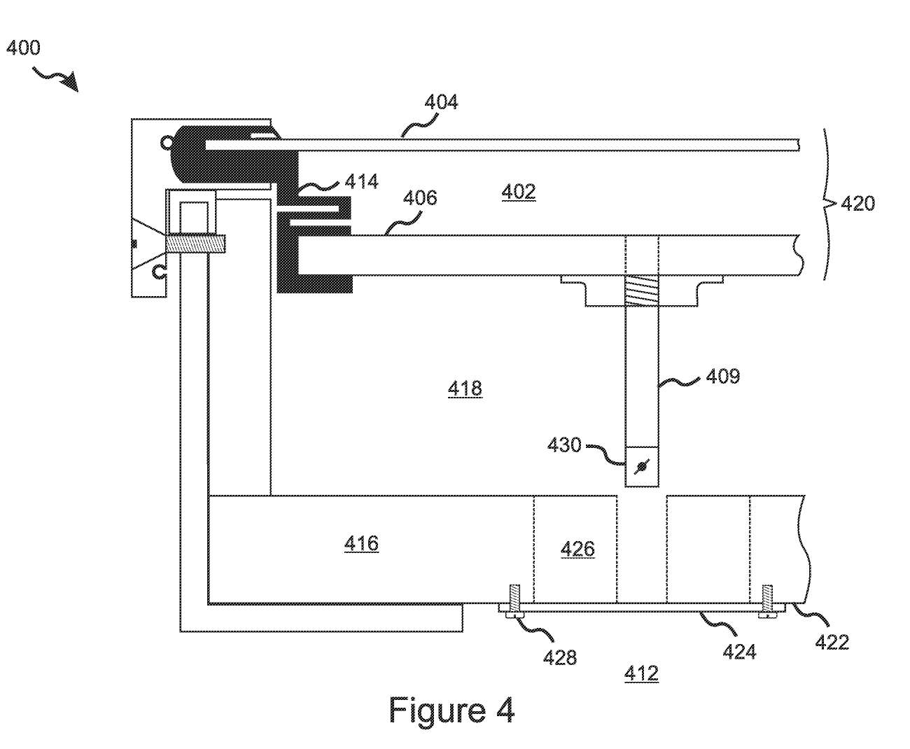

Referring now to FIG. 4, there is shown a partial cross section view of a solar collector 400 embodiment somewhat similar to the embodiments of FIGS. 1-3, illustrating a solar absorption assembly 420 comprising an absorber plate 406 and a glass outer layer 404 sealed together in a spaced-apart parallel relationship by an expandable silicone gasket 414 so as to form an expandable chamber 402 therebetween. The solar absorption assembly 420 is attached by its top edge to an insulated collector base 416 so as to form a plenum 418 within which the absorber plate 406 is suspended by the expandable gasket 414. The chamber 402 is configured with at least one small chamber-charging system including a charging tube 409 that pierces the absorber plate 406 and an access cover 424 mounted by screws 428 to the backside 422 of the base 416 so as to provide external access. The chamber-charging system enables the chamber 402 to be filled with or purged by air or another suitable gas, such as argon or krypton. In the embodiment of FIG. 4, the charging system is configured with a valve 430 that can be used to seal the chamber 402 after it is charged.

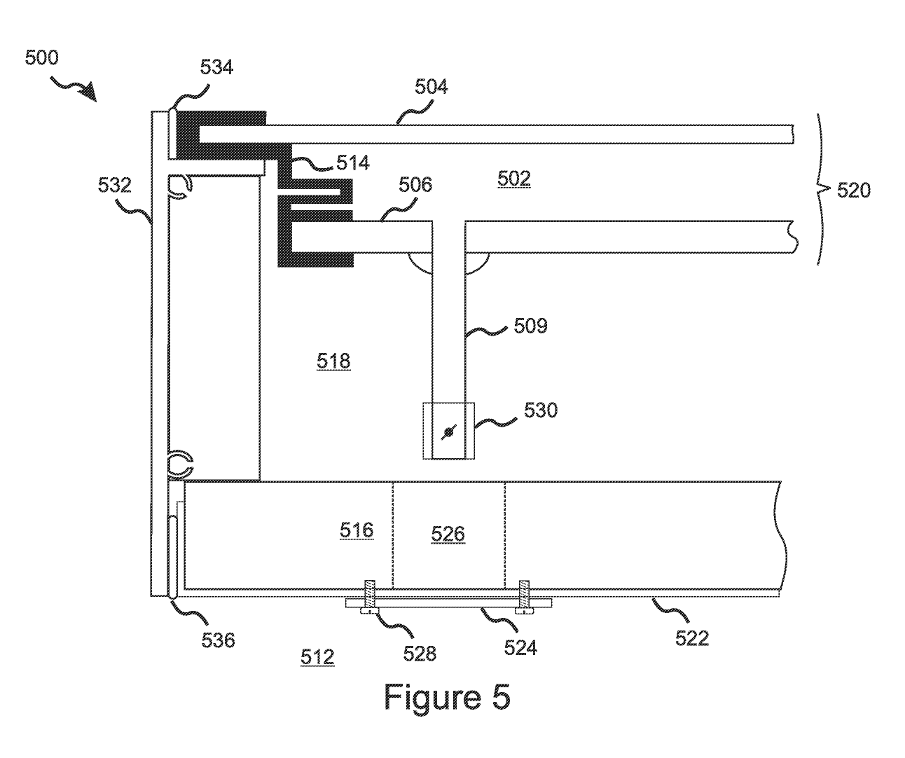

Referring to FIG. 5, there is shown a partial cross section view of a solar collector 500 similar to the solar collector 400 of FIG. 4, illustrating a solar absorption assembly 520 comprising an absorber plate 506 and a glass outer layer 504 sealed together in a spaced-apart parallel relationship by an expandable silicone gasket 514 so as to form an expandable chamber 502 therebetween, wherein the gasket 514 is shown to be sealed to the glass 504 and the absorber plate 506 on three surfaces. In the embodiment of FIG. 5, the potting of the solar absorption assembly 520 to the collector shell 532 permits removal of the solar collector assembly 520 from the front of the collector shell 532 by cutting or otherwise removing or destroying front side potted seal 534. Furthermore, the potting of the insulated backside 516 to the collector shell 532 permits removal of the insulated backside 516 so as to provide access to the plenum 518 from the backside of the solar absorber 506, for example from the inside of a building, by cutting or otherwise removing or destroying the backside potted seal 536.

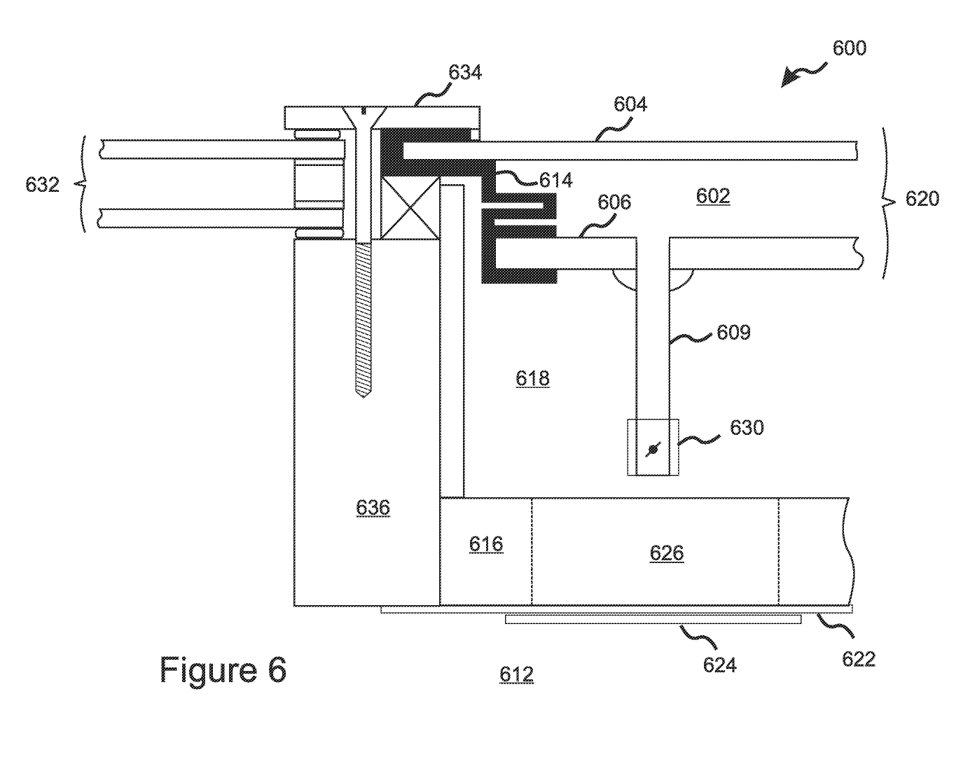

Referring now to FIG. 6, there is shown a partial cross section view of a solar collector 600 illustrating a solar absorption assembly 620 comprising an absorber plate 606 and a glass outer layer 604 sealed together in a spaced-apart parallel relationship by an expandable silicone gasket 614 so as to form an expandable chamber 602 therebetween similar to the chamber 402 of FIG. 4, wherein the gasket 614 is shown to be sealed to the glass 614 and to the absorber plate 606 on three surfaces, in contrast to the adjacent conventional double-glazed window 632 with less sealing protection, both of which are secured by a batten 634 to the same structural member 636.

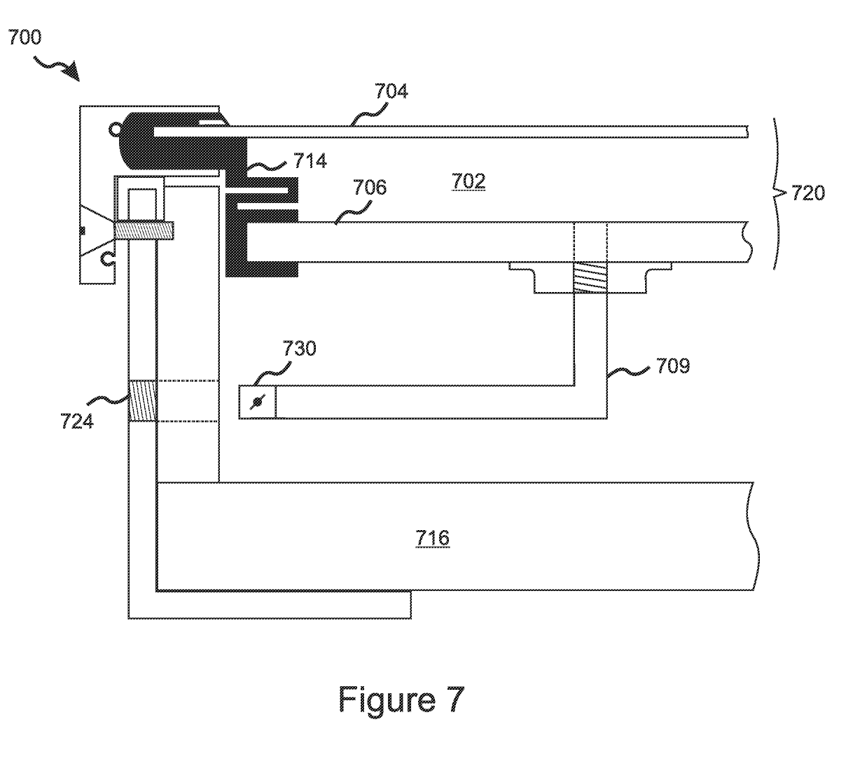

Referring to FIG. 7, there is shown a partial cross section view of a solar collector 700 very similar to the solar collector 400 of FIG. 4, except that the charging tube 709 pierces the sidewall of the base 716 so as to provide external access for charging of the chamber 702 with air or another gas.

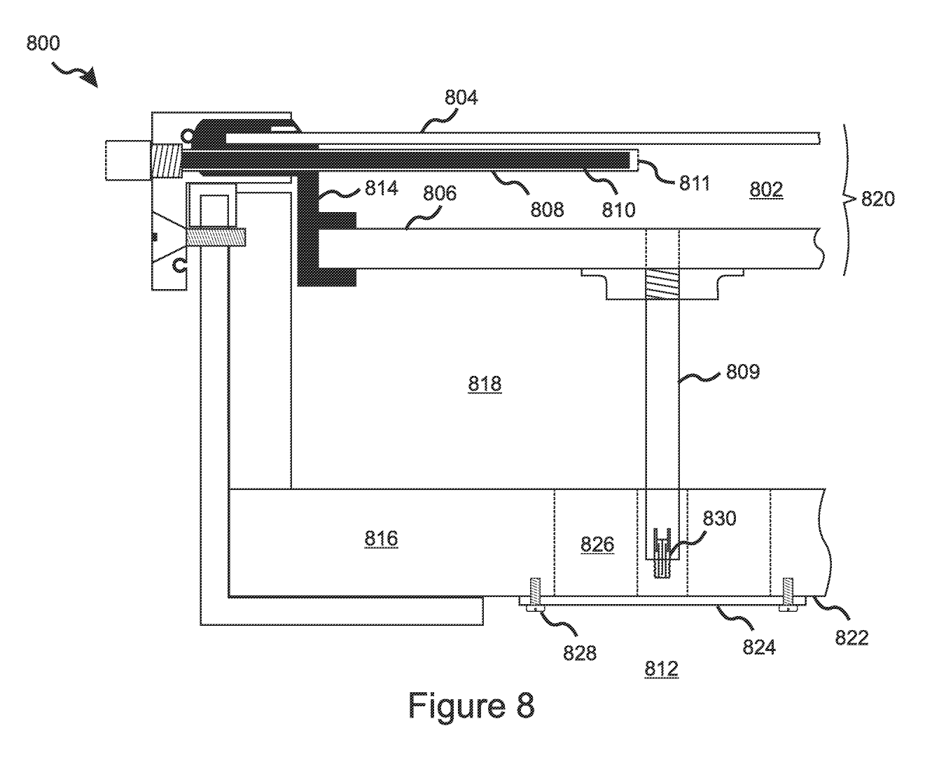

Referring to FIG. 8, elements of the above embodiments are clearly illustrated in this fixed volume chamber embodiment 800 which is equipped with both a desiccant plug 810 and vent tube 808 covered at one end by a screen 811, and with a charging system, including a charging tube 809, valve stem 830, and access cover 824 with insulation 826, so as to provide the operating options described above.

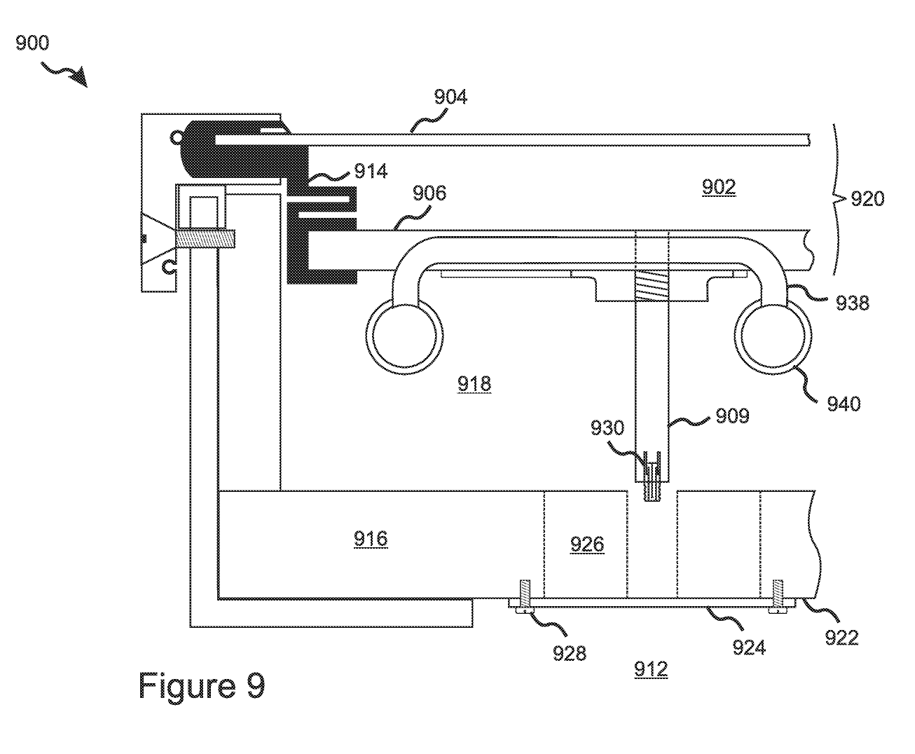

Referring to FIG. 9, there is shown a partial cross section view of a solar collector 900 having an absorber plate 906 conductively incorporating heating tubes 938 for a hot water or fluid circulation heating system. A solar collection assembly 920 comprises a glass outer layer 904 that is sealed to the absorber plate 906 in a spaced-apart parallel relationship by an expandable silicone gasket 914, which in various embodiments is a rubber gasket or a gasket of other suitable material, so as to form an expandable sealed chamber 902. The solar absorption assembly 920 is attached by its top edge to an insulated collector base 916 so as to form a plenum 918 therebetween and suspend the absorber plate 906 from the expandable gasket 914 within the plenum 918. The chamber 902 is configured with at least one small chamber charging system including a charging tube 909 piercing the absorber plate 906 and the backside 922 of the base 916 by which the chamber 902 may be filled and/or purged with air or with another gas. The charging system is configured with a valve stem 930 that can be used to seal the chamber 902 after it has been charged. The heating tubes 938 are connected at each end to a pair of headers 940 behind the absorber plate 906. The two headers 940 are connectable by flexible couplings to a hot water or fluid circulation heating circuit (not shown).

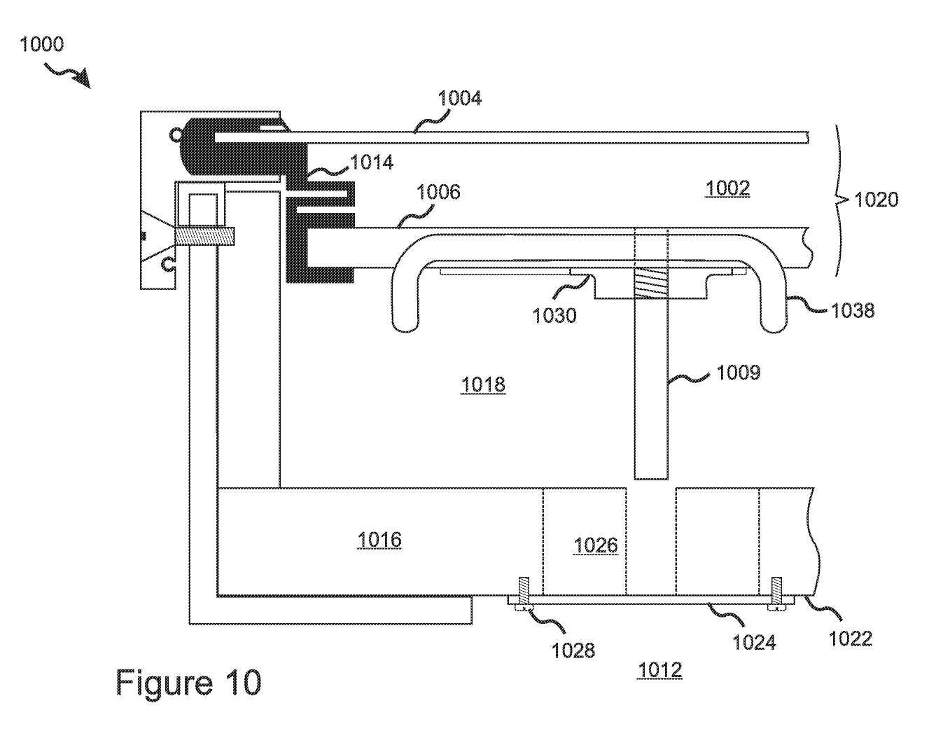

Referring to FIG. 10, there is shown a solar collector embodiment 1000 similar to the embodiment 900 of FIG. 9 for heating water or another fluid in a fluid circulation system, except that a serpentine coil 1038 in the absorber 1006 is arranged so that portions of the coil 1038 are conductively incorporated into the structure of the absorber 1006 for heat transfer to the fluid. The ends of the serpentine coil 1038 are flexibly connected to the fluid circulation loop (not shown). The absorber 1006 is charged and functions otherwise as described above for the embodiment of FIG. 4.

Embodiments of the present invention include multiple vents and/or multiple charging systems in the solar collector unit. In some embodiments, vents are configured as one way vents by incorporation of check valves or other means so that out-gassing from the chamber is directed appropriately and makeup air for the sealed chamber as the chamber breaths in during cooling is supplied from a suitable source, which may be a manufactured or controlled source of dry air or gas. As illustrated in FIG. 3B, multiple solar collectors may be connected to a common source of dry air or gas. The source of dry air or gas may be pressurized to a small degree, providing a limited but positive pressure in and airflow through the chamber of the collector or through chambers of a plurality of collectors.

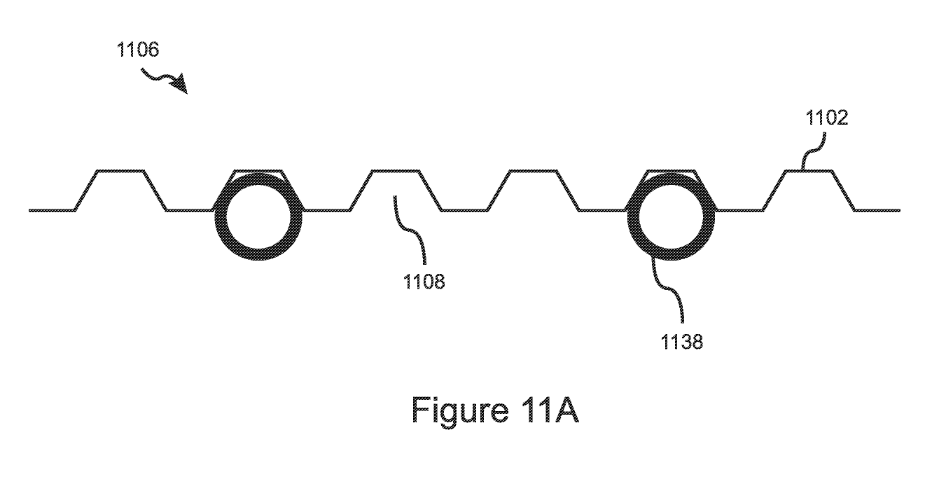

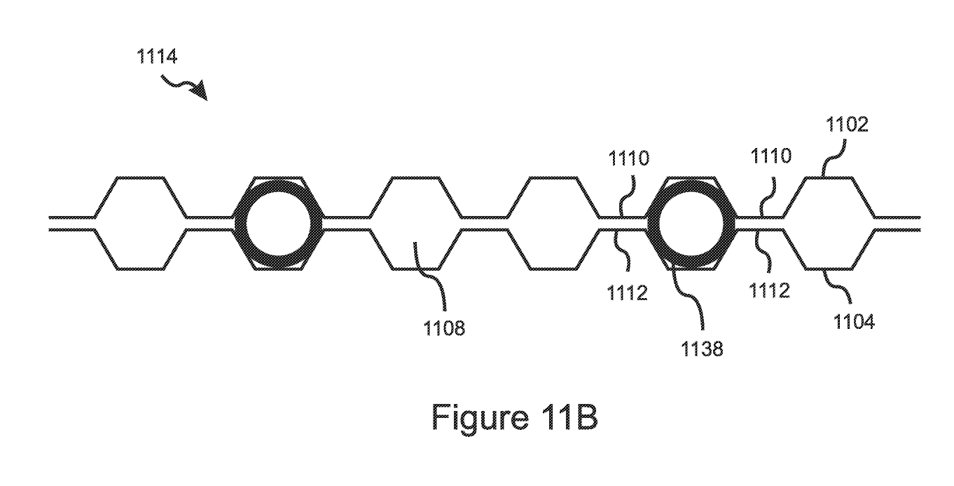

Referring now to FIG. 11A, there is shown a partial cross section diagram of an absorber plate 1106 which is formed by a single sheet of light-absorbing, heat-conducting corrugated material 1102. Linear sections of fluid carrying heating tubes 1138 are secured within the corrugated indentations 1108 by ultrasonic welding, laser welding, and/or by other means known in the art.

The ends of the tubes 1138 in some embodiments are configured to extend from the absorber plate 1106 by simple bends or fittings, while in other embodiments the absorber plates 1106 are themselves bent along one or a pair of suitable bend lines (not shown) out of the plane of the tubes 1138, exposing the ends of the tubes 138 for connection thereto. The exposed ends of the tubes 1138 can be connected in series or in parallel for suitable fluid flow, as is well known in the art.

FIG. 11B illustrates an embodiment 1114 similar to FIG. 11A, wherein the absorber includes top 1102 and bottom 1104 sheets of corrugated material, arranged so that the corrugations are aligned lengthwise and offset laterally, thereby forming an alternating pattern of available openings 1108 between opposing corrugations. Linear sections of fluid carrying heating tubes 1138 are secured within the openings 1108 by friction fit and/or by various methods of attachment known in the art. The sheets of corrugated material 1102, 1104 make contact with each other along mating flats 1110, 1112 that can be fastened to each other by any method known in the art to provide suitable mechanical strength and durability so as to retain the joints and retain the physical contact of the tubes 1138 with the absorber plates 1106 along multiple lines of contact. The method of fastening can include, but is not limited to, spot or continuous welding techniques, ultrasonic welding, laser welding, through-hole fasteners, and the use of adhesives. Some embodiments include flexible connections that can accommodate relative movements of the absorber plates 1106 caused by expansion and contraction of the chambers 1108.

The absorber plates 1106, 1114 for a solar collector illustrated in FIGS. 11A and 11B can be used as the absorber plates 906. 1006 of the solar collectors 900, 1000 of FIGS. 9 and 10, and can provide efficient and cost effective assemblies which are easily constructed and installed for transferring the heat energy produced by a solar collector to the fluid in a fluid circulation system.

While the invention has been described and illustrated with reference to embodiments identified as solar collectors, the principals of the present invention are equally applicable and adaptable to insulated multi-glazed windows, such as double-glazed or triple-glazed glass windows, that utilize sealed chambers between glass layers to retain a thermal differential between interior and exterior spaces. Such multi-glazed windows are considered solar collectors for purposes of the present invention, since they include a light-transmissive first or outside layer and a subsequent intermediate or interior layer, wherein a sealed gap or chamber is formed between the two layers which can contain air or another gas. Such multi-layer windows are subject to eventual thermal loads and pressure cycles that cause seal deterioration and moisture/condensate problems which degrade the appearance and performance of the windows, in much the same way that solar collectors are subject to performance degradation due to essentially the same issues.

It should be noted that for various multi-glazed window embodiments of the present invention that include one or more vents with desiccant plugs, the vents are directed to outside air, unless the interior environment is controlled at a relatively low moisture content.

In another aspect of the present invention, some existing building windows, whether single-glazed, double-glazed, or triple-glazed, may be reconfigured from the interior of a building as solar collectors, without disturbing the outer pane of glass, by applying the techniques of the invention described herein. For example, in a high rise building, a selected vertical row of windows on a side with adequate solar exposure could be efficiently reconfigured as solar collectors in accordance with the invention, further augmented with localized or system-integrated heating controls as is well understood in the art, so as to augment the building's heating system, thereby reducing dependence on other energy sources.

The foregoing description of the embodiments of the invention has been presented for the purposes of illustration and description. It is not intended to be exhaustive or to limit the invention to the precise forms disclosed. Many modifications and variations are possible in light of this disclosure. It is intended that the scope of the invention be limited not by this detailed description, but rather by the claims appended hereto.

What is claimed is:

1. A solar device having a pressure-stabilized chamber into which moisture entry is inhibited, the solar device comprising:
a first, light-transmissive panel;
a second panel adjacent to the first panel, the first panel and the second panel being maintained in a spaced-apart relationship by at least one joining seal, so as to form a solar chamber therebetween;
a venting system configured to provide gas communication between the solar chamber and an exterior gas environment so as to minimize temperature-induced pressure fluctuations within the sealed chamber; and
a desiccant-filled chamber cooperative with the venting system and configured so as to require gas to pass through the desiccant-filled chamber and be dried thereby before flowing into the solar chamber.

2. The solar device of claim 1, wherein the second panel is a light-transmissive panel.

3. The solar device of claim 1, wherein the second panel is a solar energy absorbing panel.

4. The solar device of claim 1, wherein the venting system is a vent tube.

5. The solar device of claim 1, wherein the venting system and desiccant-filled chamber are configured so as to require gas flowing out of the sealed chamber to flow through the desiccant-filled chamber.

6. The solar device of claim 1, wherein the at least one joining seal maintains the first and second panels in a spaced-apart relationship having a fixed distance therebetween.

7. The solar device of claim 1, wherein the at least one joining seal maintains the first and second panels in a spaced-apart relationship having a distance therebetween that is variable in response to temperature changes of a gas contained within the solar chamber, thereby mitigating pressure changes of the gas contained within the solar chamber.

8. The solar device of claim 1, wherein the desiccant-filled chamber is removable from the solar device.

9. The solar device of claim 1, further comprising a venting valve that can be adjusted so as to at least restrict gas flow through the vent passage.

10. The solar device of claim 1, further comprising a gas flow control system configured to permit flow of gas between the sealed chamber and the exterior gas environment only when a predetermined pressure differential exists between the sealed chamber and the exterior gas environment.

11. The solar device of claim 1, further comprising a recharging system configured for purging and replenishing gas within the chamber.

12. The solar device of claim 11, further comprising a recharging valve that can be shut so as to prevent gas flow through the recharging system.

13. The solar device of claim 11, wherein the recharging system is removable from the solar device.

14. The solar device of claim 1, wherein the gas is one of air, nitrogen, argon, and krypton.

15. The solar device of claim 1, wherein the second panel is a solar energy absorbing panel formed by a corrugated sheet having corrugation channels therein, the corrugated sheet having a light-absorbing exterior surface, at least some of the corrugation channels having fluid-conducting tubes installed therein and attached thereto, each of the fluid-conducting tubes being in thermal communication with the corrugated sheet, ends of the fluid-conducting tubes being available for connection to a fluid circulation system.

16. The solar device of claim 1, wherein the second panel is a solar energy absorbing panel formed by two corrugated sheets, at least one of the corrugated sheets having a light-absorbing exterior surface, the corrugated sheets being fixed to each other in a parallel and offset alignment so as to cause opposing corrugations to form parallel channels therebetween, the channels being separated by joinable flats, at least some of the channels having fluid-conducting tubes installed therein, each fluid-conducting tube being in thermal communication with the at least one corrugated sheet having a light-absorbing exterior surface, ends of the fluid-conducting tubes being available for connection to a fluid circulation system.

17. The solar device of claim 1, further comprising an insulated shell, the insulated shell being cooperative with the first and second panels so as to form a hot-air plenum bounded by the second panel and the insulated shell.

18. The solar device of claim 1, further comprising fluid-conduction tubing configured so as to bring a fluid flowing through the tubing into thermal communication with the second panel.

19. The solar device of claim 1, wherein the exterior gas environment is a source of dry gas.

20. The solar device of claim 19, wherein the source of dry gas is a controlled source of dry gas configured so as to maintain a gas pressure within the chamber which is elevated above a surrounding ambient air pressure.

21. The solar device of claim 1, wherein the exterior gas environment is a gas maintenance system which includes a pressurized source of gas having a pressure-regulated output, and an expansion chamber having a volume which is at least ten times greater than a volume of the solar chamber.

22. The solar device of claim 21, wherein the gas maintenance system is configurable so as to provide the exterior gas environment for a plurality of solar devices.
